(19) United States
(12) Patent Application Publication
(10) Pub. No.: US 2015/0149214 A1
(43) Pub. Date: May 28, 2015

(54) CLINICAL INFORMATION DISPLAY APPARATUS, METHOD AND PROGRAM

(71) Applicant: FUJIFILM Corporation, Tokyo (JP)

(72) Inventor: Fumitake TANAKA, Kanagawa-ken (JP)

(73) Assignee: FUJIFILM Corporation, Tokyo (JP)

(21) Appl. No.: 14/547,799

(22) Filed: Nov. 19, 2014

(30) Foreign Application Priority Data
Nov. 22, 2013 (JP) 2013-241488

(51) Int. Cl. G06F 19/00

(52) U.S. Cl. CPC G06F 19/3487; G06F 19/322
USPC 705/3

(57) ABSTRACT

When plural clinical-items are classified as a major clinical-item or as a related clinical-item and clinical-data of the major clinical-item or items are mainly displayed in initial display, whether each of related clinical-items includes clinical-data judged as data that need to be displayed is decided by judging whether each of at least one set of clinical-data belonging to each of the related clinical-items needs to be displayed by using a whether-to-display judgment criterion for judging whether to display that has been set in advance. In initial display, clinical-data of the related clinical-item that has been decided as a related clinical-item including the clinical-data that need to be displayed are displayed in addition to clinical-data of the major clinical-item or items, but no clinical-data of the related clinical-item that has been decided as a related clinical-item including no clinical-data that need to be displayed are displayed.

### CROSS-REFERENCE TO RELATED APPLICATIONS

The present application claims priority under 35 U.S.C. §119 to Japanese Patent Application No. 2013-241488, filed on Nov. 22, 2013. The above application is hereby expressly incorporated by reference, in its entirety, into the present application.

### BACKGROUND OF THE INVENTION

1. Field of the Invention

The present invention relates to a clinical information display apparatus, method and program for selectively displaying, in a unit of one clinical item, clinical data of plural clinical items.

2. Description of the Related Art

In medical fields, processing for displaying, on a display device, plural kinds of clinical information, such as results of examination performed on a patient, as reference information for diagnosing a disease name or deciding a treatment policy is performed. Various kinds of examination are performed on a patient. Therefore, in medical scenes, clinical data of a clinical item to which attention should be paid in diagnosing the patient need to be more efficiently recognized in such a large amount of accumulated data.

Therefore, in a clinical information display apparatus according to a related art, each of plural clinical items is classified as one of major clinical items or as a related clinical item related to one of the major clinical items. An initial display screen displays clinical data of only the major clinical items. Meanwhile, clinical data of the related clinical item are displayed at desirable timing by being arbitrarily expanded by a user, such as a doctor, or collapsed to return to a non-display state. In this manner, the apparatus tried to make efficient reference to patient's clinical information to which attention should be paid possible.

Further, International Patent Publication No. 04/023994 (Patent Document 1) discloses a technique for displaying each set of examination data (clinical information) in such a manner that whether each set of displayed examination data represents a normal value or an abnormal value, which is not within a normal range, is visually distinguishable when plural sets of examination data are displayed on a display screen.

### SUMMARY OF THE INVENTION

In the aforementioned display method, clinical data of only the major clinical items are displayed in initial display, and clinical data of the related clinical item are appropriately displayable based on an instruction input by a user later. The method is effective to improve the efficiency of reference mainly to clinical information of major clinical items. However, since clinical data of the related clinical items are excluded from the initial display, there is a problem that the user may fail to notice clinical information in clinical data of the related clinical items which should be referred to in diagnosis.

In view of the foregoing circumstances, it is an object of the present invention to provide a clinical information display apparatus, method and program to prevent a user from failing to notice, in clinical data of related clinical items, clinical information which should be referred to in diagnosis when each of plural clinical items is classified as a major clinical item or as a related clinical item, and the major clinical item or items are mainly displayed in initial display.

A clinical information display apparatus of the present invention classifies each of plural clinical items, as one of at least one major clinical item or as one of at least one related clinical item related to one of the at least one major clinical item, and selectively displays, in a unit of one clinical item, clinical data of each of the plural clinical items on a display screen. The apparatus includes a whether-to-display decision unit that decides whether each of the at least one related clinical item includes clinical data judged as data that need to be displayed by judging whether each of at least one set of clinical data belonging to each of the at least one related clinical item needs to be displayed by using a whether-to-display judgment criterion for judging whether to display each of the at least one set of clinical data, and the criterion having been set in advance, and a display control unit that displays, on an initial display screen when the clinical data are displayed, clinical data of the at least one related clinical item that has been decided by the whether-to-display decision unit as a related clinical item including the clinical data that need to be displayed in addition to clinical data of the at least one major clinical item, but displays no clinical data of the at least one related clinical item that has been decided by the whether-to-display decision unit as a related clinical item including no clinical data that need to be displayed.

Here, the term “clinical data” means a wide variety of medical data obtained to perform diagnosis and treatment on a patient. Examples of the clinical data are data representing examination information, such as information about examination on a sample and image examination information, data representing treatment information, such as drug administration information, data representing diagnosis information, such as an electronic chart and a hospital discharge summary in which doctors recorded information about diagnosis, such as a diagnosis, a symptom and a surgical treatment on a patient who is to be displayed, and data representing patient's biological information, such as body temperature, blood pressure and a respiratory rate of the patient who is to be displayed. For example, in examination of samples, when examination data for each of at least one examination item have been obtained on each examination date, the examination data on each of the examination dates may be used as clinical data of a corresponding clinical item.

In the clinical information display apparatus of the present invention, the display control unit may include history information about whether at least each set of the clinical data of each of the at least one related clinical item that has been judged as data that need to be displayed was displayed in the past, and decide, based on the history information, whether each of the at least one set of clinical data that has been judged as data that need to be displayed was displayed in the past. The display control unit may display, on the initial display screen when the clinical data are displayed, no clinical data of each of the at least one related clinical item in which all sets of clinical data judged as data that need to be displayed are judged as data displayed in the past, and display information indicating that the at least one related clinical item that includes clinical data that need to be displayed but is not displayed is present.

Here, the term “initial display screen” means a first display screen displaying clinical information based on an input of an instruction by a user to start display of clinical information. Further, the term “past” means the past with respect to a point of time when display of clinical information is started this time. The expression “whether . . . displayed in the past” means whether clinical data that need to be displayed was present in display of clinical information in the past ended before starting display of clinical information this time.

In the clinical information display apparatus of the present invention, the display control unit may display each set of clinical data of each of the at least one related clinical item including at least one set of clinical data judged as data that need to be displayed in such a manner that whether each set of the clinical data is a set of clinical data that need to be displayed is visually distinguishable when clinical data of the at least one related clinical item including the at least one set of clinical data judged as data that need to be displayed are displayed.

Further, in the clinical information display apparatus of the present invention, the display control unit may identify one of the at least one major clinical item to which the at least one related clinical item including at least one set of clinical data judged as data that need to be displayed is related, and display, on the initial display screen when the clinical data are displayed, clinical data of all of the at least one related clinical item related to the identified major clinical item. In this display, the display control unit may give priority to display of the at least one related clinical item including the clinical data that need to be displayed over display of the at least one related clinical item including no clinical data that need to be displayed.

In the clinical information display apparatus of the present invention, the display control unit may identify one of the at least one major clinical item to which the at least one related clinical item including at least one set of clinical data judged as data that need to be displayed is related, and display, on the initial display screen when the clinical data are displayed, the number of the at least one related clinical item that is related to the identified major clinical item and includes clinical data that need to be displayed in a display area of the identified major clinical item.

Further, in the clinical information display apparatus of the present invention, the whether-to-display decision unit may judge whether each set of the clinical data of the at least one related clinical item is abnormal by using an abnormality judgment criterion for judging abnormality that has been set in advance, and judge that at least one set of clinical data judged as abnormal data is clinical data that need to be displayed.

A clinical information display method of the present invention is performed by a clinical information display apparatus including a whether-to-display decision unit and a display control unit. In the method, each of plural clinical items is classified, as one of at least one major clinical item or as one of at least one related clinical item related to one of the at least one major clinical item, and clinical data of each of the plural clinical items are selectively displayed, in a unit of one clinical item, on a display screen. The method includes a first step in which the whether-to-display decision unit decides whether each of the at least one related clinical item includes clinical data judged as data that need to be displayed by judging whether each of at least one set of clinical data belonging to each of the at least one related clinical item needs to be displayed by using a whether-to-display judgment criterion for judging whether to display each of the at least one set of clinical data, and the criterion having been set in advance, and a second step in which the display control unit displays, on an initial display screen when the clinical data are displayed, clinical data of the at least one related clinical item that has been decided by the whether-to-display decision unit as a related clinical item including the clinical data that need to be displayed in addition to clinical data of the at least one major clinical item, but displays no clinical data of the at least one related clinical item that has been decided by the whether-to-display decision unit as a related clinical item including no clinical data that need to be displayed.

In the second step of the clinical information display method of the present invention, the display control unit may decide whether each of the at least one set of clinical data that has been judged as data that need to be displayed was displayed in the past by using history information about whether at least each set of the clinical data of each of the at least one related clinical item that has been judged as data that need to be displayed was displayed in the past, and display, on the initial display screen when the clinical data are displayed, no clinical data of each of the at least one related clinical item in which all sets of clinical data judged as data that need to be displayed are judged as data displayed in the past, and display information indicating that the at least one related clinical item that includes clinical data that need to be displayed but is not displayed is present.

A clinical information display program of the present invention classifies each of plural clinical items, as one of at least one major clinical item or as one of at least one related clinical item related to one of the at least one major clinical item, and selectively displays, in a unit of one clinical item, clinical data of each of the plural clinical items on a display screen. The program causes a computer to function as each unit of the clinical information display apparatus of the present invention. The program is recorded on a recording medium, such as a CD-ROM and a DVD, or recorded in a storage attached to a server computer or in a network storage in a downloadable manner, and provided for users.

According to the clinical information display apparatus, method and program of the present invention, when each of plural clinical items is classified, as one of at least one major clinical item or as one of at least one related clinical item related to one of the at least one major clinical item, and clinical data of each of the plural clinical items are selectively displayed in a unit of one clinical item on a display screen, whether each of the at least one related clinical item includes clinical data judged as data that need to be displayed is decided by judging whether each of at least one set of clinical data belonging to each of the at least one related clinical item needs to be displayed by using a whether-to-display judgment criterion for judging whether to display each of the at least one set of clinical data, and the criterion having been set in advance. Further, in addition to clinical data of the at least one major clinical item, clinical data of the at least one related clinical item decided as a related clinical item including the clinical data that need to be displayed are displayed on an initial display screen when the clinical data are displayed, but no clinical data of the at least one related clinical item decided as a related clinical item including no clinical data that need to be displayed are displayed. Therefore, when each of plural clinical items is classified as a major clinical item or as a related clinical item, and initial display is performed by displaying mainly a major clinical item or items, it is possible to prevent a user from failing to notice, in clinical data of related clinical items, clinical information which should be referred to in diagnosis.

Note that the program of the present invention may be provided being recorded on a computer readable medium. Those who are skilled in the art would know that computer readable media are not limited to any specific type of device, and include, but are not limited to: floppy disks, CD's, RAM's, ROM's, hard disks, magnetic tapes, and internet downloads, in which computer instructions can be stored and/or transmitted. Transmission of the computer instructions through a network or through wireless transmission means is also within the scope of this invention. Additionally, computer instructions include, but are not limited to: source, object and executable code, and can be in any language including higher level languages, assembly language, and machine language.

### BRIEF DESCRIPTION OF THE DRAWINGS

FIG. 1 is a schematic diagram illustrating the configuration of a medical information system to which a clinical information display apparatus of the present invention has been applied;

FIG. 2 is a diagram illustrating an example of a hierarchical structure of clinical items classified as major clinical items or as related clinical items;

FIG. 3 is a diagram illustrating an example of an initial display screen displayed by a display control unit;

FIG. 4 is a diagram illustrating an example of the initial display screen displayed by the display control unit;

FIG. 5 is a diagram illustrating an example of the initial display screen displayed by the display control unit; and

FIG. 6 is a diagram illustrating an example of the initial display screen displayed by the display control unit.

### DESCRIPTION OF THE PREFERRED EMBODIMENTS

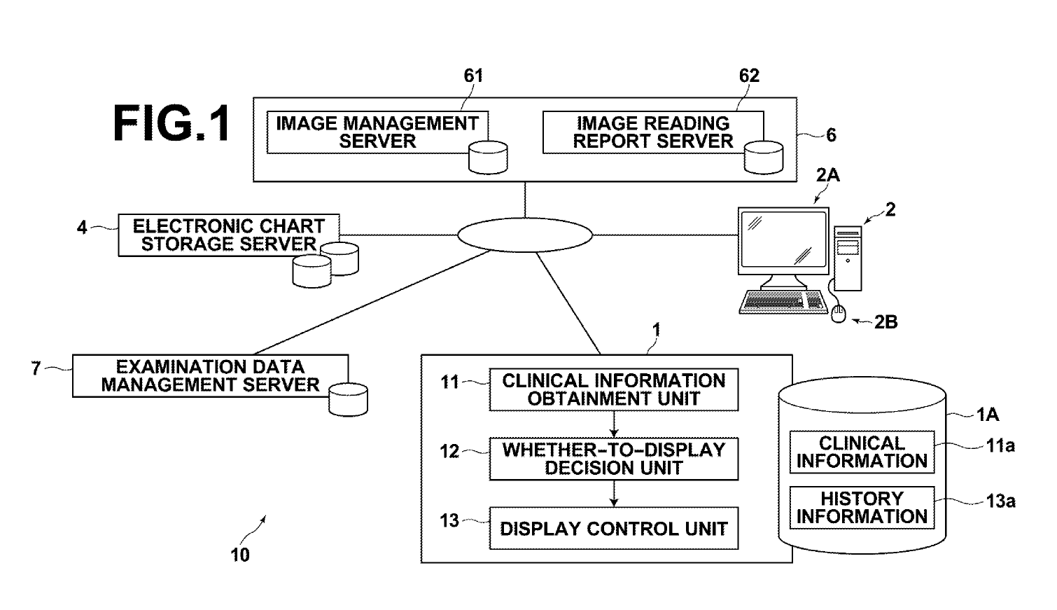

Hereinafter, a medical information system to which a clinical information display apparatus according to an embodiment of the present invention has been applied will be described. FIG. 1 is a schematic diagram illustrating the configuration of this medical information system 10, and which is also a functional block diagram of a clinical information display apparatus 1.

As illustrated in FIG. 1, the medical information system 10 is configured by connecting a clinical information display apparatus 1, a clinical department terminal 2, an electronic chart management server 4, an image diagnosis system 6 and an examination data management server 7 through a network in such a manner that they can communicate with each other.

The electronic chart management server 4 is a computer including an electronic chart database in which electronic charts are stored. In the computer, software for retrieving, based on a request at the clinical department terminal 2 or the like, an image related to each electronic chart and clinical information, such as an examination result, and sending and receiving the result of retrieval has been installed in addition to an operating system and software for managing the database. The electronic chart management server 4 is connected to the clinical information display apparatus 1, the clinical department terminal 2, the examination data management server 7 and the image diagnosis system 6 through a network in such a manner to be able to obtain each clinical information related to the electronic charts.

The examination data management server 7 is a computer including an examination data management database in which examination data are stored. In the computer, software for managing the examination data has been installed in addition to standard software, such as an operation system. Examination data of each of plural examination items about samples are obtained on each examination date based on an examination order that has been input at each clinical department terminal 2. The examination data and information about the examination dates are input at an examination room terminal located in each examination room in such a manner to be related to the examination order and a patient's ID. Further, the examination data and the information about the examination dates are stored in the examination data management database through a network.

The image diagnosis system 6 is a known computer system. Here, the system is configured by connecting, through a network, a workstation for a doctor in charge of image-based diagnosis, modalities, such as a CT and an MRI, an image management server 61 including an image database and a image reading report server 62 including a image reading report database in such a manner that they can communicate with each other. The image database stores image data obtained by imaging by the modalities, such as a CT and an MRI, and the image reading report database stores image reading reports including results of image reading on the images obtained by imaging. The workstation for a doctor in charge of image-based diagnosis is configured by installing various kinds of image analysis processing software in such a manner that various kinds of image analysis processing are performable based on a purpose of diagnosis and a target of diagnosis.

The clinical department terminal 2 is a computer used by a doctor in a clinical department or the like to retrieve patient's clinical information and to input an examination order or the like. The clinical department terminal 2 includes a display unit 2A, which is a general display, and an input unit 2B including a keyboard and a mouse. The clinical department terminal 2 is used also to display and refer to clinical information, such as data of a result of an examination performed by each clinical department and a generated electronic chart. Standard software, such as an operation system, and application software for displaying clinical information, such as a generated electronic chart, have been installed in the clinical department terminal 2.

In an embodiment of the present invention, when the clinical department terminal 2 receives an operation of instruction for starting display of clinical information and an operation of selecting (or inputting) necessary information, such as a patient's ID, by a user, such as a doctor, using the input unit 2B, the clinical department terminal 2 sends various instructions for displaying clinical information and, if necessary, data corresponding to the various instructions to a clinical information display device 1, which will be described later. The clinical information display apparatus 1 receives these various instructions (and corresponding data, if necessary), and sends information necessary to display clinical information in the embodiment of the present invention, such as plural pieces of clinical information corresponding to the input patient's ID, to the clinical department terminal 2. Then, the clinical department terminal 2 receives these kinds of information necessary to display clinical information, and displays, based on the received information, a clinical information display screen, which will be described later, on the display screen of the display unit 2A of the clinical department terminal 2.

The clinical information display apparatus 1 is a computer including clinical information management database 1A. An operating system and software for managing the database have been installed in the computer. The clinical information display apparatus 1 has a function also as a server for managing clinical information. The clinical information display apparatus 1 is connected, through a network, to the electronic chart management server 4, the clinical department terminal 2, the examination data management server 7, the image management server 61 and the image reading report server 62. The clinical information display apparatus 1 obtains clinical information 11a, such as an electronic chart of the patient, various kinds of examination result data, image data and an image reading report, by retrieving them, based on a patient's ID, from each server or the like connected to the clinical information display apparatus 1. Further, the clinical information display apparatus 1 stores the obtained clinical information 11a in the clinical information management database 1A in such a manner to be related to each patient's ID. The clinical information display apparatus 1 updates clinical information to be managed every day at fixed time. Besides, the clinical information display apparatus 1 updates, based on a request by each server or the like, information by receiving each clinical information appropriately sent from each server or the like. Further, the clinical information display apparatus 1 updates, based on its own need, information by appropriately obtaining each clinical information from each server or the like.

In the clinical information display apparatus 1, a clinical information display program according to an embodiment of the present invention has been installed. When the clinical information display program is executed, the clinical information display apparatus 1 functions as a clinical information obtainment unit 11, a whether-to-display decision unit 12 and a display control unit 13. The clinical information obtainment unit 11 obtains patient's clinical information 11a and stores the patient's clinical information 11a in the clinical information management database 1A, as described above. The whether-to-display decision unit 12 decides whether each of the at least one related clinical item includes clinical data judged as data that need to be displayed by judging whether each of at least one set of clinical data belonging to each of the at least one related clinical item needs to be displayed by using a whether-to-display judgment criterion for judging whether to display each of the at least one set of clinical data, and the criterion having been set in advance. The display control unit 13 controls display of clinical information on the display screen.

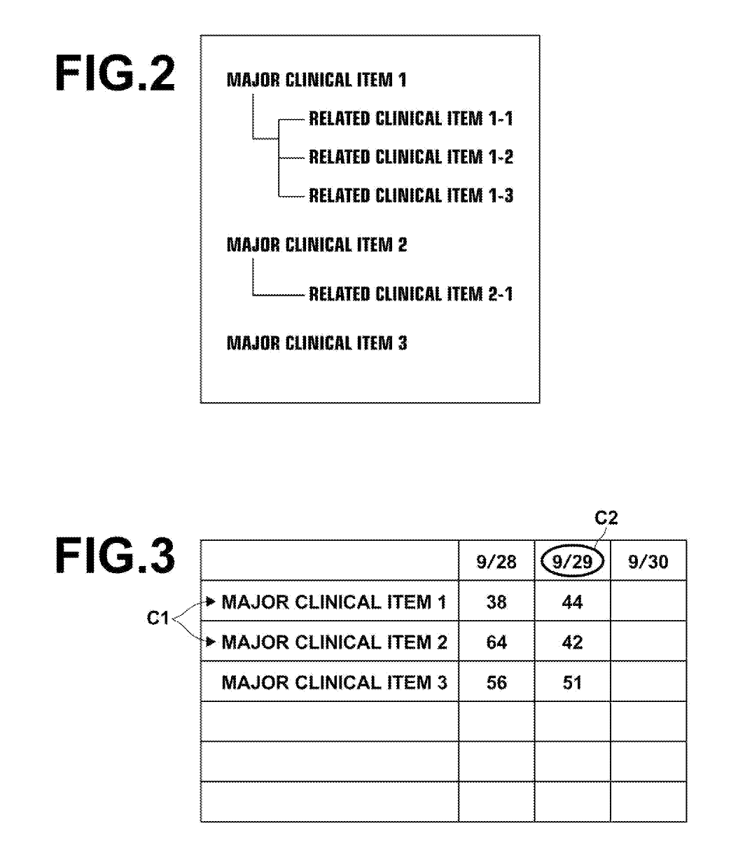

For example, when an operation of instruction for starting display of clinical information and an operation of inputting necessary information, such as a patient's ID, by a user, such as a doctor, are received at the clinical department terminal 2, the clinical information obtainment unit 11 obtains clinical information by retrieving it, based on the input patient's ID, from the electronic chart management server 4, the examination data management server 7, the image management server 61 and the image reading report server 62. Further, the clinical information obtainment unit 11 stores the obtained clinical information in the clinical information management database 1A. The clinical information management database 1A stores, as clinical information 11a, each of at least one set of clinical data belonging to each of plural clinical items in such a manner that each of the at least one set of clinical data is related to information of a registration data of the at least one set of clinical data, respectively. Meanwhile, each of the plural clinical items has been classified, as one of major clinical items or as a related clinical item related to one of the major clinical items, based on a rule that was set in advance. FIG. 2 is a diagram illustrating an example of a hierarchical structure of clinical items classified as major clinical items or as related clinical items.

Then, the whether-to-display decision unit 12 decides, with respect to each of the related clinical items included in the patient's clinical information 11a stored in the clinical information management database 1A, whether each of the related clinical items includes clinical data judged as data that need to be displayed by judging whether to display each of the at least one set of clinical data belonging to the related clinical item. At this time, a judgment criterion for judging abnormality corresponding to the content of the clinical item is prepared for each of the at least one related clinical item. The whether-to-display decision unit 12 judges, by using the judgment criterion corresponding to the related clinical item, whether each set of the clinical data of the related clinical item is abnormal, and judges that a set of clinical data judged as abnormal data is clinical data that need to be displayed.

The abnormality is judged basically based on whether clinical data to be judged as to the abnormality are outside a predetermined reference value range (normal values). At this time, the abnormality judgment criterion may be appropriately set and modified based on the clinical information history of the patient to be diagnosed. For some clinical items, abnormality of clinical data is judged by further considering other clinical data on each examination date within a certain time period that has been set based on the examination date of the clinical data to be judged in addition to the clinical data to be judged as to abnormality. For example, abnormality of data may be judged based on whether a series of clinical data including the clinical data to be judged increased or decreased to an abnormal side by a fluctuation width of a predetermined reference value or more, or based on whether the clinical data to be judged remained outside the predetermined reference value range for a predetermined time period or more in a certain time period that has been set based on the examination date of the clinical data to be judged.

Next, the display control unit 13 generates and displays an initial display screen of clinical information based on clinical information 11a about the patient stored in clinical information management database 1A. The display control unit 13 displays, on the initial display screen of clinical information, clinical data of the at least one related clinical item that has been decided by the whether-to-display decision unit 12 as a related clinical item including the clinical data that need to be displayed in addition to clinical data of the at least one major clinical item, but displays no clinical data of the at least one related clinical item that has been decided by the whether-to-display decision unit 12 as a related clinical item including no clinical data that need to be displayed.

For example, when plural kinds of clinical information having a hierarchical structure as illustrated in FIG. 2 are displayed, if the whether-to-display decision unit 12 has decided that none of related clinical items 1-1 through 1-3 and 2-1 includes any clinical data that need to be displayed, the display control unit 13 generates and displays an initial display screen in which clinical data of only major clinical items 1 through 3 are displayed, for example as illustrated in FIG. 3. At this time, triangle button C1 for opening and closing is provided immediately on the left side of the displayed clinical item name of each of major clinical items 1 and 2, each having at least one related clinical item. The initial display screen is structured in such a manner that clinical data of the at least one related clinical item related to the major clinical item are displayable by being expanded based on an operation of the button by a user, and that the expanded clinical data are collapsible so that the clinical data of the at least one related clinical item are not displayed. FIG. 3 illustrates a display screen displaying clinical data of each of September 28 and September 29 (today) for each of major clinical items 1 through 3. The date (September 29) corresponding to today is indicated by round enclosing line C2.

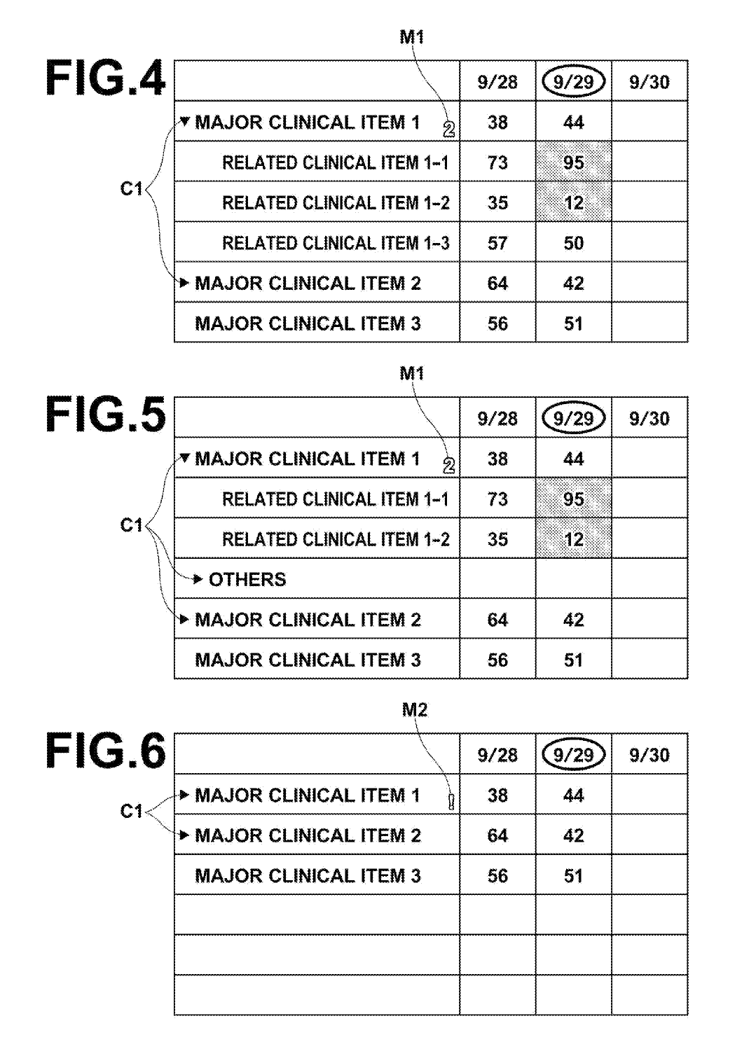

Meanwhile, if the whether-to-display decision unit 12 has decided that each of related clinical items 1-1 and 1-2 includes clinical data that need to be displayed, the display control unit 13 generates and displays an initial display screen in which clinical data of related clinical items 1-1 and 1-2, each of which has been judged as a related clinical item including clinical data that need to be displayed, are further displayed in addition to clinical data of major clinical items 1 through 3, for example as illustrated in FIG. 4. In the display screen illustrated in FIG. 4, each cell of clinical data that have been judged as data that need to be displayed by the whether-to-display decision unit 12 is colored. The display control unit 13 displays each clinical data in such a manner that whether each of the clinical data is clinical data that need to be displayed is visually distinguishable by using a method of coloring a cell displaying clinical data judged as clinical data that need to be displayed in a different color from the other cells as described above, or the like.

As illustrated in FIG. 4, the display control unit 13 may identify major clinical item 1 to which related clinical items 1-1 and 1-2, each including clinical data that need to be displayed, is related. Further, the display control unit 13 may display clinical data of all of related clinical items 1-1 through 1-3 related to the identified major clinical item 1 (related clinical item 1-3, which includes no clinical data that need to be displayed, is included). At this time, the display control unit 13 adjusts the order of arrangement of plural related clinical items related to the same major clinical item in such a manner that priority is given to display of at least one related clinical item including clinical data that need to be displayed over display of the other related clinical items. Human eyes ordinarily move from left to right and up to down. Therefore, for example, when plural related clinical items are arranged in an up-down direction and displayed, at least one clinical item each including clinical data that need to be displayed is displayed at a higher position. When plural related clinical items are arranged in a left-right direction and displayed, at least one clinical item each including clinical data that need to be displayed is displayed on the left side.

Further, the display control unit 13 may display number M1 of at least one related clinical item that is related to the major clinical item and includes clinical data that need to be displayed in a display area (in FIG. 4, a right-side corner of a cell in which a clinical item name is displayed) of the major clinical item to which the at least one clinical item including clinical data that need to be displayed is related, as illustrated in FIG. 4.

The display control unit 13 may generate and display an initial display screen, for example as illustrated in FIG. 5, instead of the display screen illustrated in FIG. 4. The display screen illustrated in FIG. 5 omits display of related clinical item 1-3, which includes no clinical data that need to be displayed. The display screen illustrated in FIG. 5 displays only related clinical items 1-1 and 1-2, which include clinical data that need to be displayed. Display of related clinical item 1-3 including no clinical data that need to be displayed is omitted.

Further, the display control unit 13 stores, in clinical information management database 1A, history information 13a about whether at least each set of the clinical data of each of the at least one related clinical item that has been judged as data that need to be displayed was displayed in the past that ended before starting display of clinical information this time. The display control unit 13 decides, based on history information 13a, whether each set of clinical data that has been judged by the whether-to-display decision unit 12 as data that need to be displayed was displayed in the past. The display control unit 13 displays only clinical data of a related clinical item including clinical data that need to be displayed and have not been displayed. The display control unit 13 omits display of clinical data of a related clinical item in which all of clinical data that have been judged as data that need to be displayed were judged as data displayed in the past. When display of the related clinical item including clinical data that need to be displayed is omitted, the display control unit 13 displays information that a related clinical item that includes clinical data that need to be displayed but is not displayed is present.

For example, when an input of an instruction by a user to start display of the same clinical information is received again after display of clinical information on the display screen illustrated in FIG. 4 or FIG. 5 is finished, the display control unit 13 may omit display of related clinical items 1-1 and 1-2, as illustrated in FIG. 6, because clinical data that need to be displayed of both of related clinical items 1-1 and 1-2 have been displayed. Further, the display control unit 13 may display mark M2 indicating that a related clinical item that includes clinical data that need to be displayed but is not displayed is present in a cell displaying a clinical item name of major clinical item 1 to which these related clinical items are related or the like. FIG. 6 illustrates an example of a display screen in which an exclamation mark is used to indicate presence of a related clinical item that is not displayed. Instead of this display (or in addition to this display), display of the number of related clinical items including clinical data that need to be displayed may be used as display indicating that a related clinical item that is not displayed is present, as illustrated in FIG. 4 or FIG. 5.

As described above, according to the medical information system 10 in an embodiment of the present invention, when each of plural clinical items is classified as one of at least one major clinical item or as one of at least one related clinical item related to one of the at least one major clinical item, and clinical data of each of the plural clinical items is selectively displayed, in a unit of one clinical item, on a display screen, the whether-to-display decision unit 12 decides whether each of the at least one related clinical item includes clinical data judged as data that need to be displayed by judging whether each of at least one set of clinical data belonging to each of the at least one related clinical item needs to be displayed by using a whether-to-display judgment criterion for judging whether to display each of the at least one set of clinical data, and the criterion having been set in advance. Further, the display control unit 13 displays, on an initial display when the clinical data are displayed, clinical data of the at least one related clinical item that has been decided by the weather-to-display decision unit 12 as a related clinical item including the clinical data that need to be displayed in addition to clinical data of the at least one major clinical item, but displays no clinical data of the at least one related clinical item that has been decided by the weather-to-display decision unit 12 as a related clinical item including no clinical data that need to be displayed.

Therefore, when each of plural clinical items is classified as a major clinical item or as a related clinical item, and initial display is performed by displaying mainly clinical data of the major clinical item or items, it is possible to prevent a user from failing to notice, in clinical data of related clinical items, clinical information which should be referred to in diagnosis.

Further, the display control unit 13 includes history information about whether at least each set of the clinical data of each of the at least one related clinical item that has been judged as data that need to be displayed was displayed in the past, and decides, based on the history information, whether each set of the clinical data that has been judged as data that need to be displayed was displayed in the past, and omits display, on the initial display screen when the clinical data are displayed, clinical data of each of the at least one related clinical item in which all sets of clinical data judged as data that need to be displayed are judged as data displayed in the past, and displays information indicating that the at least one related clinical item that includes clinical data that need to be displayed but is not displayed is present. Therefore, even if the number of related clinical items including data that need to be displayed increases as clinical data are accumulated, it is possible to suppress the number of related clinical items to be displayed. Hence, it is possible to maintain high efficiency in referring to clinical information.

In the above embodiment of the present invention, a case in which the display control unit 13 judges whether clinical data that need to be displayed were displayed in display of clinical information in the past ended by the time of starting display of clinical information this time was described. Instead, judgment may be made as to whether clinical data that need to be displayed were displayed in display of clinical information ended by some point of time in the past before the starting point of display of clinical information of this time. Here, as some point of time in the past, for example, a specific point of time in the past specified by a user, a point of time going back to the past from a starting point of display of clinical information of this time by a certain period, or the like may be used.

The present invention is not limited to the aforementioned embodiments. A part or all of composition elements of the clinical information display apparatus may be configured by a workstation. Alternatively, the clinical information display apparatus may be configured by at least one workstation, a server and a storage device connected to each other through a network. Each equipment is controlled by a program described in the specification of the present application, and which is installed from a recording medium, such as a CD-ROM. The program may be installed after being downloaded from a storage apparatus of a server connected through a network, such as the Internet.

The aforementioned embodiments represent only one of modes of the present invention. The present invention may be arbitrarily modified and applied without departing from the gist of the present invention.

What is claimed is:

1. A clinical information display apparatus that classifies each of a plurality of clinical items, as one of at least one major clinical item or as one of at least one related clinical item related to one of the at least one major clinical item, and selectively displays, in a unit of one clinical item, clinical data of each of the plurality of clinical items on a display screen, the apparatus comprising:
a whether-to-display decision unit that decides whether each of the at least one related clinical item includes clinical data judged as data that need to be displayed by judging whether each of at least one set of clinical data belonging to each of the at least one related clinical item needs to be displayed by using a whether-to-display judgment criterion for judging whether to display each of the at least one set of clinical data, and the criterion having been set in advance; and
a display control unit that displays, on an initial display screen when the clinical data are displayed, clinical data of the at least one related clinical item that has been decided by the whether-to-display decision unit as a related clinical item including the clinical data that need to be displayed in addition to clinical data of the at least one major clinical item, but displays no clinical data of the at least one related clinical item that has been decided by the whether-to-display decision unit as a related clinical item including no clinical data that need to be displayed.

2. The clinical information display apparatus, as defined in claim 1, wherein the display control unit includes history information about whether at least each set of the clinical data of each of the at least one related clinical item that has been judged as data that need to be displayed was displayed in the past, and decides, based on the history information, whether each set of the clinical data that has been judged as data that need to be displayed was displayed in the past, and displays, on the initial display screen when the clinical data are displayed, no clinical data of each of the at least one related clinical item in which all sets of clinical data judged as data that need to be displayed are judged as data displayed in the past, and displays information indicating that the at least one related clinical item that includes clinical data that need to be displayed but is not displayed is present.

3. The clinical information display apparatus, as defined in claim 1, wherein the display control unit displays each set of clinical data of each of the at least one related clinical item including at least one set of clinical data judged as data that need to be displayed in such a manner that whether each set of the displayed clinical data is a set of clinical data that need to be displayed is visually distinguishable when clinical data of the at least one related clinical item including the at least one set of clinical data judged as data that need to be displayed are displayed.

4. The clinical information display apparatus, as defined in claim 1, wherein the display control unit identifies one of the at least one major clinical item to which the at least one related clinical item including at least one set of clinical data judged as data that need to be displayed is related, and displays, on the initial display screen when the clinical data are displayed, clinical data of all of the at least one related clinical item related to the identified major clinical item.

5. The clinical information display apparatus, as defined in claim 4, wherein the display control unit gives priority to display of the at least one related clinical item including clinical data that need to be displayed when the clinical data of all of the at least one related clinical item related to the identified major clinical item are displayed.

6. The clinical information display apparatus, as defined in claim 1, wherein the display control unit identifies one of the at least one major clinical item to which the at least one related clinical item including at least one set of clinical data judged as data that need to be displayed is related, and displays, on the initial display screen when the clinical data are displayed, the number of the at least one related clinical item that is related to the identified major clinical item and includes clinical data that need to be displayed in a display area of the identified major clinical item.

7. The clinical information display apparatus, as defined in claim 1, wherein the whether-to-display decision unit judges whether each set of the clinical data of the at least one related clinical item is abnormal by using an abnormality judgment criterion for judging abnormality that has been set in advance, and judges that at least one set of clinical data judged as abnormal data is clinical data that need to be displayed.

8. A clinical information display method performed by a clinical information display apparatus including a whether-to-display decision unit and a display control unit,
wherein each of a plurality of clinical items is classified, as one of at least one major clinical item or as one of at least one related clinical item related to one of the at least one major clinical item, and clinical data of each of the plurality of clinical items are selectively displayed in a unit of one clinical item on a display screen, and the method comprising:
a first step in which the whether-to-display decision unit decides whether each of the at least one related clinical item includes clinical data judged as data that need to be displayed by judging whether each of at least one set of clinical data belonging to each of the at least one related clinical item needs to be displayed by using a whether-to-display judgment criterion for judging whether to display each of the at least one set of clinical data, and the criterion having been set in advance; and
a second step in which the display control unit displays, on an initial display screen when the clinical data are displayed, clinical data of the at least one related clinical item that has been decided by the weather-to-display decision unit as a related clinical item including the clinical data that need to be displayed in addition to clinical data of the at least one major clinical item, but displays no clinical data of the at least one related clinical item that has been decided by the weather-to-display decision unit as a related clinical item including no clinical data that need to be displayed.

9. The clinical information display method, as defined in claim 8, wherein in the second step, the display control unit decides whether each of the at least one set of clinical data that has been judged as data that need to be displayed was displayed in the past by using history information about whether at least each set of the clinical data of each of the at least one related clinical item that has been judged as data that need to be displayed was displayed in the past, and displays, on the initial display screen when the clinical data are displayed, no clinical data of each of the at least one related clinical item in which all sets of clinical data judged as data that need to be displayed are judged as data displayed in the past, and displays information indicating that the at least one related clinical item that includes clinical data that need to be displayed but is not displayed is present.

10. A non-transitory computer-readable recording medium having stored therein a clinical information display program that classifies each of a plurality of clinical items, as one of at least one major clinical item or as one of at least one related clinical item related to one of the at least one major clinical item, and selectively displays, in a unit of one clinical item, clinical data of each of the plurality of clinical items on a display screen, the program causing a computer to function as:
a whether-to-display decision unit that decides whether each of the at least one related clinical item includes clinical data judged as data that need to be displayed by judging whether each of at least one set of clinical data belonging to each of the at least one related clinical item needs to be displayed by using a whether-to-display judgment criterion for judging whether to display each of the at least one set of clinical data, and the criterion having been set in advance; and
a display control unit that displays, on an initial display screen when the clinical data are displayed, clinical data of the at least one related clinical item that has been decided by the whether-to-display decision unit as a related clinical item including the clinical data that need to be displayed in addition to clinical data of the at least one major clinical item, but displays no clinical data of the at least one related clinical item that has been decided by the whether-to-display decision unit as a related clinical item including no clinical data that need to be displayed.
